(19) United States
(12) Patent Application Publication
(10) Pub. No.: US 2008/0166687 A1
(43) Pub. Date: Jul. 10, 2008

(54) Inside Words

(76) Inventor: Ardella McClarty, White Plains, NY (US)

Correspondence Address: COLLEN IP, THE HOLYOKE MANHATTAN BUILDING, 80 SOUTH HIGHLAND AVENUE, OSSINING, NY, 10562, US

(21) Appl. No.: 11/621,370

(22) Filed: Jan. 9, 2007

(51) Int. Cl. G09B 19/22

(52) U.S. Cl. 434/129

(57) ABSTRACT

An educational gaming device and method consisting of individual cards containing personal information of specific public figures in numerous areas, including sports, entertainment politics, such as Hip Hop and R&B, etc. The playing cards are categorized into each of these areas. Children can play various games with these cards based on the celebrity's personal information. The games include word games, spelling games and memorization games. The front of each card contains a celebrity's full name. Based on the letters in the celebrity's name, the children playing will create a list of words within a set time period. Children receive points for the total number of words that are properly spelled. From the list of words that a child identifies, he/she then will create sentences. From the sentences created, the child will then be expected to identify the type of word (nouns, verbs, adjectives, pronouns and adverbs, etc). From the sentences created, the child will also define any word that they are not familiar with.

### BACKGROUND OF THE INVENTION

Games which include listing words from a larger word are well known, especially in an academic setting. The use of cards to play games for educational purposes is also well known. These educational card games, however, will motivate interest of the person playing the game. It can be challenging to discover ways to capture and engage the interests of children in school systems. This invention relates to educational card games, which can guide children, as well as adults, in games of reading, spelling, and memorizing by enhancing their vocabulary. The cards may contain, for example, personal information of various artists in the entertainment industry that people are familiar with. By capturing their attention with the content of the cards, instructors can guide the players in various word games which help the players bolster their literary, math and social studies skills. Points are allotted to each person playing, based on an individual, timed performance in each game. This educational tool provides an exciting way to get people involved in learning fundamental academic skills.

### SUMMARY

An educational game that utilizes a known person's information to engage participant's in literary exercises to improve academic skills. The known people are selected to be in categories such as Hip Hop, Gospel, Rock 'n Roll, Comedians and local figures in a community.

### BRIEF DESCRIPTION OF DRAWINGS

FIG. 1 is a depiction of the front of a typical card

FIG. 2 is a depiction of the back of a typical card

### PREFERRED EMBODIMENTS OF THE INVENTION

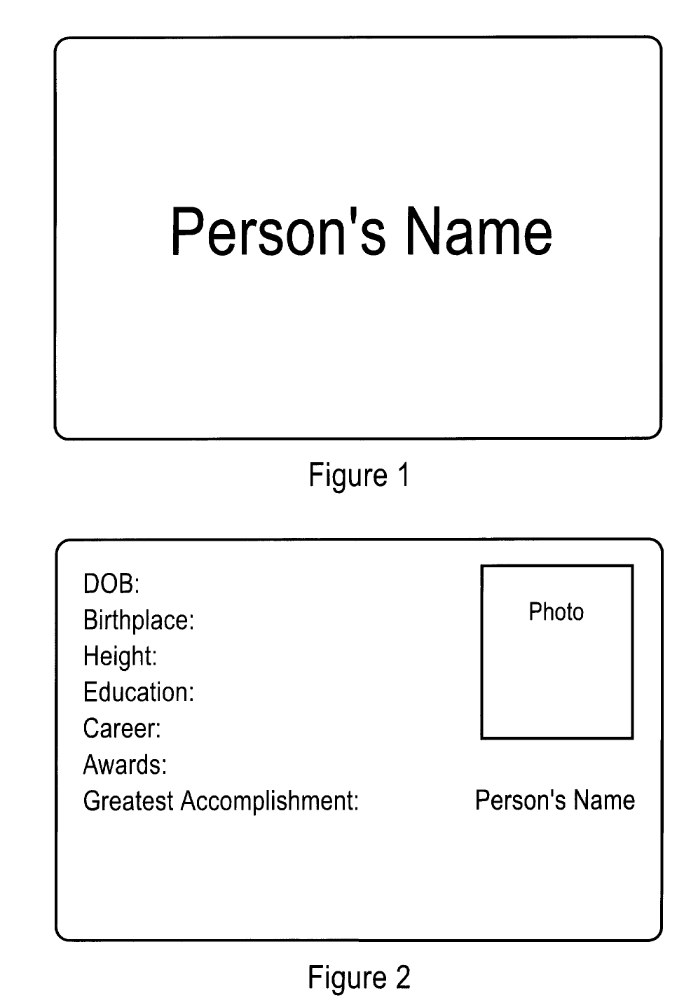

The present invention provides a method for teaching reading, spelling, math, social studies and vocabulary, and an educational gaming device typically containing a set of cards, a lesson plan, a pencil, a timer and a notepad. A typical card (FIGS. 1 & 2) is 3″ by 5″ and contains a glossy finish over a black and white photograph and black and white print. Each card contains the name of a public figure from one category such as: Hip Hop, Gospel, Literary Authors, Actors and Actresses, Talk Show Hosts, Sports, Entrepreneurs, R&B, Rock 'N Roll, Television, Comedians, Fashion Industry, Magazine, Politicians, and figures involved in the community, (for example pastors and bishops). On the front side of the card (FIG. 1) is the full name of the public figure. On the back of each card (FIG. 2) is a picture, some biographical information and celebrity website which gives them free Advertisement. The cards can be divided into the categories. Each celebrity category contains a minimum of 25 public or otherwise known figures. Cards can easily be added or deleted in any category to ensure the figures are interesting to the particular people playing the game.

The cards can be utilized in a number of methods to help people learn to read, spell, form thoughts and sentences, vocabulary and mental exercise. Based on the educational level of those playing the game and the intended objective, the method utilized in the game can be varied.

In one variation the player selects a card from a category. The card contains either the first and last name of the celebrity or the first, middle and last name of the celebrity. From the name written on the card, the player has a time limit to find words contained with name(s) displayed. The amount of time is ten (10) minutes per card (Timer). The player receives a point for each word properly identified and spelled and ½ point for Abbr. and ten (10) points for using each letter in the entire name.

In a second variation, the player has a time limit to find words contained in the entire name (combined letter in all names) of the celebrity. The player receives a point for each word properly identified and spelled. The number of points can be set to reflect the length or complexity of the words identified, for example: Curtis/Rustic (Curtis James Jackson II “50 cent”).

In a third variation the player has a time limit to identify each word created in the first and second method above into its proper grammatical category. Each word is to be labeled as a verb, noun, adjective, etc. The player receives a point for each word properly identified in each of the respective grammatical categories. “Grammar Crunch-N-Bunch”.

In a fourth variation of the game, the player has a time limit to define the words listed and categorized. The player receives a point for each word properly defined.

In a fifth variation, the player has an allotted time to properly use the words in a sentence. Again the players are awarded point(s) for accomplishing the objective defined.

In a sixth variation, the players are tested verbally or in writing on information provided on the back of the card. Points are awarded for correct answers.

In a seventh variation, the players are directed to do research on the public figure, his/her home town, or some other specified parameter. Points are awarded based on quality of the information formed by participant.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. An educational gaming device comprising:
a set of cards each displaying the name of a known person's name on one side of a card and the person's picture and biographical information on the back;
the cards are based on categories of people known to the players;
a timing device;
a lesson plan; and
notepads for players to use

2. An educational gaming device according to claim 1 in which the objective of the game is to identify words based on letters in the person's name within an allotted time and points are awarded based on the words identified.

3. An educational gaming device according to claim 2, in which the objective of the game is to also identify the proper grammatical category of each word identified by the player and points awarded based on proper categorization.

4. An educational gaming device according to claim 2, in which the objective of the game is to define the words identified by the player and points awarded based on the correct definition.

5. An educational gaming device according to claim 2, in which a further objective of the game is to utilize the identified words properly in a sentence and points awarded based on proper use of words in a sentence.

6. A method of playing an education game comprising:
selecting categories of people who would be interesting to the intended game participants;
identifying specific known people of interest in each category for the intended participants;
creating a card for each known person to be included in the game;
obtaining pictures of each known person placing each known person to be included in game on side 1 of a card and the picture and biographical information on side 2 of the card;
instructing the participants on the objectives and requirements for the game;
providing a writing tool to each participant;
establishing an allowed time period for the participant to complete the game;
establishing a scoring system for words identified; and
playing the game by holding of a card so that side 1 is visible and directing participants to identify words based on the letters in the name on the card.
awarding points to participants based on the words identified and the scoring established.

7. A method according to claim 6 in which the allowed time is based on the knowledge and skill of the participant.

8. A method according to claim 7 in which the categories are chosen from the group including R & B, Hip Hop, Gospel, literary authors, actors, sports, Rock 'n Roll, comedians, fictional characters, animals, politicians, scientists, figures in community and television.

9. A method according to claim 8 wherein participants are awarded points for spelling the identified words correctly.

10. A method according to claim 8 wherein participants are directed to identify in which grammatical category the word properly belongs and awarded points for doing so correctly.

11. A method according to claim 8 wherein participants are directed to define each word identified and awarded points for doing so correctly.

12. A method according to claim 8 wherein participants are directed to use the words identified in a sentence and awarded points for doing so correctly.

13. A method according to claim 8 wherein participants are tested about the information contained on the back of a card and awarded points for correct answers.

14. A method according to claim a wherein participants are directed to do research on specified parameter on the card and awarded points based on the evaluation of the research done.
